(19) United States
(12) Patent Application Publication
(10) Pub. No.: US 2008/0072070 A1
(43) Pub. Date: Mar. 20, 2008

(54) Secure virtual RAM

(75) Inventors: Michael Philip LaMacchia, Gilbert, AZ (US); Byron Tarver, Chandler, AZ (US); Bill Haber, Tempe, AZ (US); Dale Schiele, Scottsdale, AZ (US)

Correspondence Address: INGRASSIA FISHER & LORENZ, P.C., 7150 E. CAMELBACK, STE. 325, SCOTTSDALE, AZ, 85251, US

(73) Assignee: General Dynamics C4 Systems, Inc.

(21) Appl. No.: 11/512,561

(22) Filed: Aug. 29, 2006

(51) Int. Cl. G06F 12/14

(52) U.S. Cl. 713/193

(57) ABSTRACT

A secure virtual RAM securely transfers data within a device having a secure, non-volatile memory and a host. The secure virtual RAM includes a memory management component configured to direct the transfer of the data between the non-volatile memory and a processor, and an encryption/decryption component coupled to the memory management component and configured to decrypt the data provided to the processor and encrypt the data provided to the non-volatile memory. The secure virtual RAM further includes an integrity check component coupled to the encryption/decryption component and configured to monitor functional integrity, a key storage component coupled to the encryption/decryption component and configured to receive cryptographic keys and provide the cryptographic keys to the encryption/decryption component.

### TECHNICAL FIELD

The present invention relates generally to data protection techniques. More particularly, the present invention relates to secure virtual RAM that provides protection of secure data.

### BACKGROUND

Many types of data protection techniques and data communication systems that utilize encrypted data transmissions are known. Examples of applications that require data protection techniques include portable computing devices and portable memory devices. The problem with many of these portable devices is that conventional data protection techniques require unacceptable delays in access times. Access time delays detract from the performance of the devices and generally deter designers from the incorporating high assurance data protection and security.

One example of a system in which data protection can create an unacceptable delay is a software defined radio. A software defined radio is a fully reconfigurable device that can change behavior and capabilities by downloading new software to the radio. This capability creates several security concerns. One security concern that must be addressed is the prevention of the software being changed after it is stored on the device. Typically, the software is protected using encryption/decryption processes. In conventional software defined radios, the encryption/decryption processes that verify the integrity of the software are performed in a centrally located, cryptographic processor. The software must be verified by the cryptographic processor, for example, each time the software defined radio is turned on and booted up or each time the new software is downloaded to the device. The data verification required to begin operation or institute new software can take many minutes. This delay is unacceptable to most users, particularly in a portable device.

Accordingly, it is desirable to provide devices that include high assurance data protection while avoiding unacceptable delays in access times. Furthermore, other desirable features and characteristics of the present invention will become apparent from the subsequent detailed description and the appended claims, taken in conjunction with the accompanying drawings and the foregoing technical field and background.

### BRIEF SUMMARY

In one embodiment of the present invention, a secure virtual RAM is provided for securely transferring data within a device having a secure, non-volatile memory and a trusted host. The secure virtual RAM includes a memory management component configured to direct the transfer of the data between the non-volatile memory and a processor, and an encryption/decryption component coupled to the memory management component and configured to decrypt the data provided to the processor and encrypt the data provided to the non-volatile memory. The secure virtual RAM further includes an integrity check component coupled to the encryption/decryption component and configured to monitor functional integrity, and a key storage component coupled to the encryption/decryption component and configured to receive cryptographic keys and provide the cryptographic keys to the encryption/decryption component.

In another embodiment of the present invention, a high assurance device is provided. The high assurance device includes a trusted host, a first RAM configured to be coupled to a processor and configured to transfer data in and out of the processor, a secure, non-volatile memory configured to store the data to be transferred in and out of the processor, and secure virtual RAM coupled to the first RAM, the non-volatile memory, and the trusted host. The secure virtual RAM includes a memory management component configured to direct the transfer of the data between the non-volatile memory and the processor, and an encryption/decryption component coupled to the memory management component and configured to decrypt the data provided to the processor and encrypt the data provided to the non-volatile memory. The secure virtual RAM further includes an integrity check component coupled to the encryption/decryption component and configured to monitor functional integrity, and a key storage component coupled to the encryption/decryption component and configured to receive cryptographic keys and provide the cryptographic keys to the encryption/decryption component.

In yet another embodiment of the present invention, a secure memory stick is provided. The secure memory stick includes non-volatile memory for storing data to be transferred in and out of a processor, and a secure virtual RAM coupled to the non-volatile memory. The secure virtual RAM includes a memory management component configured to direct the transfer of the data between the non-volatile memory and the processor, and an encryption/decryption component coupled to the memory management component and configured to decrypt the data read from the non-volatile memory and encrypt the data written to the non-volatile memory. The secure virtual RAM further includes an integrity check component coupled to the encryption/decryption component and configured to monitor functional integrity, and a key storage component coupled to the encryption/decryption component and configured to receive cryptographic keys and provide the cryptographic keys to the encryption/decryption component.

In another embodiment of the present invention, a method of manufacturing a secure virtual RAM is provided for securely transferring data within a device having a secure, non-volatile memory and a trusted host. The method includes providing a memory management component configured to transfer the data between the non-volatile memory and the processor; providing an encryption/decryption component coupled to the memory management component and configured to decrypt the data provided to the processor and encrypt the data provided to the non-volatile memory; providing an integrity check component coupled to the encryption/decryption component and configured to monitor functional integrity; and providing a key storage component coupled to the encryption/decryption component and configured to receive cryptographic keys and provide the cryptographic keys to the encryption/decryption component.

### BRIEF DESCRIPTION OF THE DRAWINGS

A more complete understanding of the present invention may be derived by referring to the detailed description and claims when considered in conjunction with the following FIGURE, wherein like reference numbers refer to similar elements throughout the figures.

FIG. 1 is a schematic representation of the present invention.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, encryption/decryption, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. As used herein, the term “data” refers to any information represented in a form suitable for processing by computer, including software and applications.

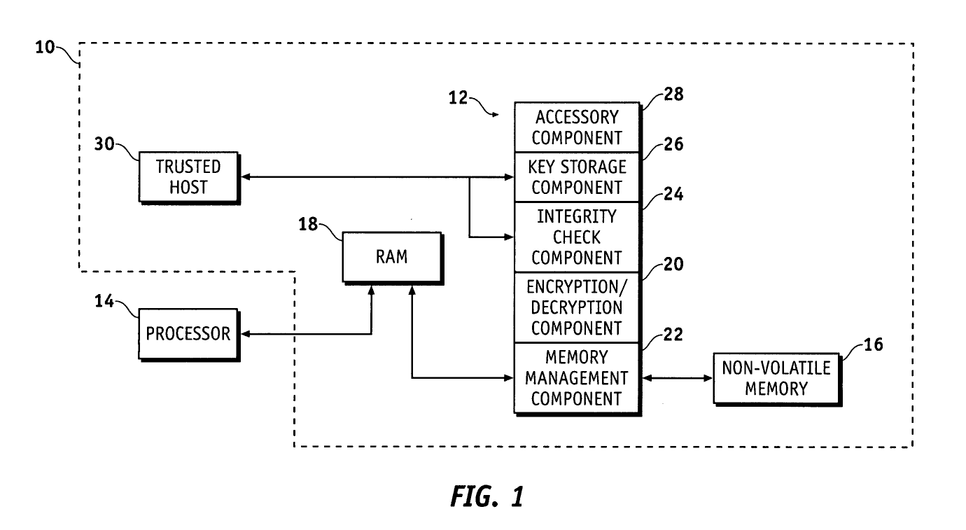

FIG. 1 illustrates secure virtual RAM 12 in a device 10 in accordance with one exemplary embodiment of the invention. The device 10 can be, for example, a software defined radio, and the device 10 is typically a high assurance device. In this embodiment, the device 10 can include a trusted host 30, RAM 18, the secure virtual RAM 12, and non-volatile memory 16. In an alternate embodiment, the device does not include RAM 18. When the device 10 is powered on, a processor 14 will attempt to load an operating system from the non-volatile memory 16 and will begin the boot-up process for the device 10. The non-volatile memory 16 can be, for example, a flash memory component, although any type of non-volatile memory can be used. It is desirable that the device 10 boot as quickly as possible, for example, in less than 10 or 20 seconds.

The secure virtual RAM 12 is placed between the non-volatile memory 16 and the processor 14 to provide encryption and decryption functions for the device 10. The secure virtual RAM 12 can be associated with a single processor or a plurality of processors. Generally, all data being written to the non-volatile memory 16 will be encrypted while all of the data being read from the non-volatile memory 16 will be decrypted. RAM 18 can be provided to store the data as it being transferred in and out of the processor 14.

The secure virtual RAM 12 includes an encryption and decryption component 20 to encrypt the data being written to the non-volatile memory 16 from the processor 14, and to decrypt the data being read from the non-volatile memory 16 and made accessible to the processor 14. Typically, the encryption and decryption processes in conventional devices result in unacceptable delays because the processes occur in the processor and slow down the processor.

The secure virtual RAM 12 further includes a key storage component 26 for managing cryptographic keys required for the encryption and decryption component 20, an integrity check component 24 for monitoring the functional integrity of the secure virtual RAM 12, and a memory management component 22 to control the transfer of data within the device 10. The functional integrity of the secure virtual RAM 12 can include the logical performance. The secure virtual RAM 12 can further include one or more accessory components 28 to provide various functions.

During boot-up of the device 10, the secure virtual RAM 12 will initialize itself while holding the processor 14 in a reset state. Once initialized, the secure virtual RAM 12 will load the required operational software from the non-volatile memory 16, decrypt the operational software, and store it in the RAM 18. Once completed, the secure virtual RAM 12 allows the processor 14 to boot from the operational software in the RAM 18.

The non-volatile memory 16 can have partitions dedicated for various functions of the device 10. For example, a partition of the non-volatile memory 16 can be dedicated to the operational software for the processor 14. In software defined radios, additional partitions can be assigned to contain the various waveforms or applications. These additional partitions can be loaded as needed by instructing the secure virtual RAM 12 to load the particular partition into RAM 18. The additional partitions can be loaded by the secure virtual RAM 12 into RAM 18 as soon as boot-up is completed or at a later time when the waveform is needed.

The encryption/decryption component 20 of the secure virtual RAM 12 may implement a version of Advanced Encryption Standard (AES) for encryption and decryption. A high assurance status of the device 10 is obtained in the secure virtual RAM 12 by performing the security critical operations under the control of the trusted host 30. The trusted host 30 can interface with any portion of the secure virtual RAM 12. The trusted host 30 can verify integrity checks at start-up by the integrity check component 24, manage the storage and distribution of storage keying material in the key storage component 26, and monitor the alarms and health checks of the integrity check component 24. The secure virtual RAM 12 can be designed with sufficient security monitoring to make it acceptable for storing sensitive data, including inputs for tamper and zeroize.

Classified software stored in the device 10, for example, part of the Type 1 Security Kernel, can be encrypted separately using Type 1 mechanisms before being stored into the secure virtual RAM 12. This will allow the secure virtual RAM 12 to provide protection for the sensitive portions of the software while double-encrypting the classified portions. Moreover, this reduces the burden on the Security Kernel so that all software does not have to be encrypted using Type 1 mechanisms, but instead, only the classified portions are to be encrypted.

The secure virtual RAM 12 can have a separate and dedicated port for loading the key material into key storage 26. The keys can be loaded from the trusted host 30, which can be for example, a cryptographic security kernel. Upon boot-up, the secure virtual RAM 12 will initialize and wait for the cryptographic keys to be loaded into the key storage 26. As soon as the keys are loaded, the boot up or other operation processes can continue. The keys are typically not stored during power down operations.

Multiple keys can be provided for a variety of functions. A user can customize the contents of the non-volatile memory 16 according to a particular function. The accessibility of the contents can be determined by the particular key supplied for operation. The keys can also be provided such that only certain users are allowed to utilize particular waveforms or presets, based on their login and particular keys.

The memory management component 22 enables the control and management of the data and software to be loaded to and from the processor 14. The processor 14 may select an application or a radio preselect and allow the memory management 22 to manage the transfer of data from the non-volatile memory 16 to RAM 18.

The accessory component 28 for the secure virtual RAM 12 can be a region for the storage of configuration and control parameters. This region can provide a backup of the RAM 18. As the configuration and control parameters are being written into RAM 18, an encrypted copy of the same information can be stored into the non-volatile memory 16 as a backup. If the device 10 must be rebooted, the configuration and control parameters can be decrypted and restored to RAM 18 at the same time as the operational software is loaded into RAM 18.

The accessory component 28 can be a power management component to enable unused resources within the device 10 to be powered down until needed. For example, portions of the encryption/decryption component 20, the memory management 22, and the non-volatile memory 16 may be put into a standby, low power state as necessary or desired.

The accessory component 28 can be a data compression component that includes compression circuitry to compress data either before or after encryption. Compression after encryption minimizes the size of the non-volatile memory 16 required to store the data. Alternately, compressing the data prior to encryption also minimizes space in the non-volatile memory 16 and can improve the speed performance of the device by increasing the rate at which data can be encrypted.

The accessory component 28 can be a memory scrubber that enables error correction within the non-volatile memory 16. Data may be corrupted in certain environments as a result of upsets due to charged particles. One example of such an environment is a space environment. Corruption may also occur terrestrially in nuclear environments, and to a lesser degree, from natural radiation in very tiny memory elements. To repair these types of errors, additional check bits may be provided in memory and used to validate the contents of each location. If sufficient check bits are provided, the errors can be isolated to a particular bit and restored to the proper value. The scrubber can visit each memory location periodically, generally at a rate higher than the rate that un-repairable errors occur. The circuitry within the secure virtual RAM 12 to read and write the memories can be employed to provide memory scrubbing. The accessory component 28 may also include a segmentation and re-assembly component for packetizing the data.

The accessory component 28 can be a data integrity component for error correction coding.

The non-volatile memory can include a plurality of protected segments, and wherein the secure virtual RAM can require a key to access the data within each of the segments. In one embodiment, the accessory component 28 can include an integrity monitor for monitoring the physical integrity of the device and for destroying the key upon an integrity breach. The integrity monitor can include a holdup voltage energy storage device such as a battery or a supercap. The integrity monitor that monitors the physical integrity can also be part of the integrity check component 24.

Generally, the exemplary embodiment of secure virtual RAM 12 has sufficient digital processing rates that assure the encryption and decryption processes are faster than the available NVRAM rates. This can be accomplished with conventional programmable logic devices, or due to increasing NVRAM rates, the exemplary embodiment can alternatively include an ASIC secure virtual RAM.

If the device 10 is a software defined radio, the device 10 can instantiate a waveform by loading it from the non-volatile memory 16. It is desirable that the waveforms be loaded in a matter of seconds to allow the user to quickly change communication protocols or applications. In conventional devices, protection mechanisms placed on the software significantly increase the boot times as well as the waveform instantiation time. In this embodiment of the present invention, the processor 14 is capable of writing to the secure virtual RAM 12 for the purpose of configuration, control, and software update. As the new software is downloaded to the device 10, the software is decrypted and sent to the appropriate portion of the processor 14. The processor 14 can be divided into secure and nonsecure subsystems, which can be designated, for example, black gpp or red gpp. The processor 14 can send the software to the secure virtual RAM 12 to be encrypted and stored into the non-volatile memory 16. The processor 14 can dictate where the software will be stored in the non-volatile memory 16 and can provide address information to the secure virtual RAM 12 along with an identifier to be used when the software is to be retrieved. The secure virtual RAM 12 writes the software in the non-volatile memory, as well as the address of the software and its identifier for later retrieval. When the software is to be retrieved, the processor 14 will send the identifier information to the secure virtual RAM 12 that will load the software from the non-volatile memory 16.

To protect the software when it is downloaded to the software defined radio, an integrity calculation can be performed on the software by the integrity check component 24 to be compared with the integrity check value included with the software. The software can then be encrypted under a locally generated key and stored in the non-volatile memory 16. When the software is loaded, for example, at boot time, the software will be decrypted using the local key. The software will also be subject to an integrity calculation and the result of the calculation can be compared to the integrity check value to make sure that the software has not been changed during storage in the non-volatile memory 16. This technique provides both integrity protection as well as confidentiality protection of the software.

The secure virtual RAM 12 within the software defined radio provides encryption and decryption services for the operating system, the operating environment, the waveforms, the applications, and the configuration/control data. The secure virtual RAM 12 can be used for all subsystems within the software defined radio for protection and integrity verification of the software. When used in conjunction with the crypto-subsystem and the additional type 1 software protection, the secure virtual RAM 12 provides a high performance, secure method of protecting the software defined radio.

In one embodiment, the present invention includes a secure memory stick incorporating the non-volatile memory 16 and the secure virtual RAM 12 that includes a high speed hardware encryption function when provided with the proper key. The secure memory stick may also include RAM 18. In this embodiment, the non-volatile memory 16 includes flash memory. When powered, the memory stick receives the keys, decrypts the contents of the non-volatile RAM 16 and places it into RAM 18. If a write back to non-volatile memory 16 is desired, prior to removal, a shutdown process copies the RAM 18 back to the non-volatile memory 16 via the secure virtual RAM 12. Keys can be a single factor, or require additional factors. To gain a two factor security, a software derived keying element could be inserted electrically through a data port provided by the user or the machine address. A second factor could be keyed into the memory stick itself via switches. Similarly, for higher factors, a variety of information could be provided by the reading device or its peripherals, such as machine ID, finger print or retinal scan.

The secure virtual RAM 12 provides a significant improvement in access time in a device 10 as compared to conventional approaches. To the user, the encryption and decryption processes can appear seamless or otherwise transparent with the other processes within the device. In addition, providing encryption and decryption, as well as memory management, and integrity checks within the secure virtual RAM 12 reduces loading on the processor 14 while maintaining high assurance and security. In effect, the secure virtual RAM 12 serves to extend a chain of trust from the trusted host to the protected applications for execution by the processing system.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A secure virtual RAM for securely transferring data within a device having a secure, non-volatile memory and a trusted host, comprising:
a memory management component configured to direct the transfer of the data between the non-volatile memory and a processor;
an encryption/decryption component coupled to the memory management component and configured to decrypt the data provided to the processor and encrypt the data provided to the non-volatile memory;
an integrity check component coupled to the encryption/decryption component and configured to monitor functional integrity; and
a key storage component coupled to the encryption/decryption component and configured to receive cryptographic keys and provide the cryptographic keys to the encryption/decryption component.

2. The secure virtual RAM of claim 1, further comprising a data compression component configured to compress the data during at least one of a) before encryption and b) after encryption.

3. The secure virtual RAM of claim 1, further comprising a storage region for storage of configuration and control parameters.

4. The secure virtual RAM of claim 1, further comprising a power management component that powers down portions of the device during a stand-by mode.

5. The secure virtual RAM of claim 1, further comprising a memory scrubber for scrubbing errors in the non-volatile memory.

6. A high assurance device, comprising:
a trusted host;
a first RAM configured to be coupled to a processor and configured to transfer data in and out of the processor;
a secure, non-volatile memory configured to store the data to be transferred in and out of the processor; and
a secure virtual RAM coupled to the first RAM, the non-volatile memory, and the trusted host,
wherein the secure virtual RAM includes
a memory management component configured to direct the transfer of the data between the non-volatile memory and the processor;
an encryption/decryption component coupled to the memory management component and configured to decrypt the data provided to the processor and encrypt the data provided to the non-volatile memory;
an integrity check component coupled to the encryption/decryption component and configured to monitor functional integrity; and
a key storage component coupled to the encryption/decryption component and configured to receive cryptographic keys and provide the cryptographic keys to the encryption/decryption component.

7. The high assurance device of claim 6, wherein the processor is a software defined radio processor.

8. The high assurance device of claim 7, wherein the data is an application, and
wherein the secure virtual RAM receives the application from the trusted host, encrypts the application, stores the application in the non-volatile memory, and upon request by the processor, decrypts the application in the non-volatile memory and provides the application to the processor.

9. The high assurance device of claim 6, wherein the non-volatile memory is flash memory.

10. The high assurance device of claim 6, wherein the key storage component receives the cryptographic keys from a trusted host.

11. The high assurance device of claim 6, wherein the data stored in the non-volatile memory is an operating system, and
wherein, during a boot-up operation, the secure virtual RAM receives the operating system, decrypts the operating system, and provides the operating system to the processor.

12. The high assurance device of claim 11, wherein the decryption of the data occurs at a rate higher than the boot-up operation.

13. The high assurance device of claim 6, wherein the secure virtual RAM requires at least one key and at least one additional security factor to access the data within the non-volatile memory.

14. The high assurance device of claim 6, wherein the non-volatile memory includes a plurality of protected segments, and wherein the secure virtual RAM requires a key to access the data within each of the segments.

15. The high assurance device of claim 14, further comprising an integrity monitor for monitoring the physical integrity of the device and for destroying the key upon an integrity breach.

16. A secure memory stick, comprising:
a non-volatile memory for storing data transferred to be transferred in and out of a processor; and
a secure virtual RAM coupled to the non-volatile memory,
wherein the secure virtual RAM includes
a memory management component configured to direct the transfer of the data between the non-volatile memory and the processor;
an encryption/decryption component coupled to the memory management component and configured to decrypt the data read from the non-volatile memory and encrypt the data written to the non-volatile memory;
an integrity check component coupled to the encryption/decryption component and configured to monitor functional integrity; and
a key storage component coupled to the encryption/decryption component and configured to receive cryptographic keys and provide the cryptographic keys to the encryption/decryption component.

17. The secure memory stick of claim 16, further comprising a first RAM coupled to a secure virtual RAM for transferring data in and out of the processor.

18. The secure memory stick of claim 16, wherein the non-volatile memory is flash memory.

19. The secure memory stick of claim 16, wherein the secure virtual RAM requires at least one key and at least one additional security factor to access the data within the non-volatile memory.

20. A method of manufacturing a secure virtual RAM for securely transferring data within a device having a secure, non-volatile memory and a trusted host, the method comprising:
providing a memory management component configured to transfer the data between the non-volatile memory and a processor;
providing an encryption/decryption component coupled to the memory management component and configured to decrypt the data provided to the processor and encrypt the data provided to the non-volatile memory;
providing an integrity check component coupled to the encryption/decryption component and configured to monitor functional integrity; and
providing a key storage component coupled to the encryption/decryption component and configured to receive cryptographic keys and provide the cryptographic keys to the encryption/decryption component.

21. The method of claim 20, wherein the device is a software defined radio, and wherein the method further comprises incorporating the secure virtual RAM into the software defined radio.
